(19) United States
(12) Patent Application Publication
(10) Pub. No.: US 2016/0225087 A1
(43) Pub. Date: Aug. 4, 2016

(54) PREFERENCE ASSESSMENT FOR DECISON ALTERNATIVES

(71) Applicant: iMatchative, Inc., San Francisco, CA (US)

(72) Inventor: Thomas Johannes Oberlechner, San Francisco, CA (US)

(21) Appl. No.: 14/608,496

(22) Filed: Jan. 29, 2015

(51) Int. Cl. G06Q 40/06; G06F 3/0481; G06F 3/0484

(52) U.S. Cl. CPC G06Q 40/06; G06F 3/04847; G06F 3/0481

(57) ABSTRACT

A machine may be configured to facilitate assessment of a user's preference for one decision alternative over another decision alternative. Accordingly, the machine may provide an intuitive preference assessment feature that generates and provides a report to help the user determine his or her true preference between at least two decision alternatives, for example, when the user has difficulty rationally deciding between at least two seemingly equal choices. The machine may automatically prompt the user to submit identifiers of decision alternatives, prompt the user to submit factual descriptors of those decision alternatives, generate an assessment for completion by the user, administer the assessment to the user, analyze submissions received from the user, and generate a report on the user's preference for one decision alternative over one or more other decision alternatives.

### TECHNICAL FIELD

The subject matter disclosed herein generally relates to machines that are configured to process data. Specifically, the present disclosure addresses systems and methods to facilitate providing a preference assessment tool for decision alternatives.

### BACKGROUND

A system of one or more machines (e.g., a cloud-based server system) may be configured (e.g., by software executing on one or more processors of such machines) to assist a human user in making decisions. For example, to assist users with choosing which products to purchase, an online shopping system may provide one or more network-based services that analyze textual descriptions of products and generate suggestions, recommendations, or advertisements for various products. Such an online shopping system may generate suggestions, recommendations, or advertisements based on one or more preferences consciously set by a user.

Conscious setting of user preferences may occur explicitly (e.g., by the user submitting a preference for a certain characteristic to the online shopping system) or implicitly (e.g., by the user purchasing a product that exhibits the characteristic, which enables the online shopping system to store an identifier of that characteristic within a preference profile of the user). In both explicit and implicit scenarios, the user consciously performs an action that is sufficient to notify the system of the user's preference for a certain characteristic when performing decision-making (e.g., setting a preference or making a purchase).

### BRIEF DESCRIPTION OF THE DRAWINGS

Some embodiments are illustrated by way of example and not limitation in the figures of the accompanying drawings.

FIG. 1 is a network diagram illustrating a network environment suitable for facilitating preference assessment for decision alternatives, according to some example embodiments.

FIG. 2 is a block diagram illustrating components of a machine suitable for performing preference assessment for decision alternatives, according to some example embodiments.

FIG. 3 is a block diagram illustrating a display with a user interface suitable for preference assessment, according to some example embodiments.

FIG. 4 is a block diagram illustrating a screen of the user interface, according to some example embodiments.

FIGS. 5 and 6 are block diagrams illustrating screens of the user interface, according to some example embodiments.

FIG. 7 is a block diagram illustrating a screen of the user interface depicting a report generated from preference assessment, according to some example embodiments.

FIGS. 8 and 9 are flowcharts illustrating operations of a machine in performing a method of preference assessment for decision alternatives, according to some example embodiments.

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems are directed to facilitating assessment of a preference (e.g., an unconscious preference) for one or more decision alternatives. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In decision-making, choosing between alternatives (e.g., decision alternatives) may be enhanced or otherwise facilitated by information (e.g., a report) produced by a machine (e.g., based on a machine-analysis of certain data). For clarity in describing various example embodiments, the discussion herein focuses on an example situation in which a user is a financial investor who is deciding between two investment alternatives (e.g., investment funds, management entities of investment funds, or investment strategies of investment funds). However, the systems and methods discussed herein are similarly applicable to other decision alternatives. Additional examples of such decision alternatives include potential business partners (e.g., investors, suppliers, or customers), potential employees (e.g., candidates for a job), potential romantic partners (e.g., candidates for dating), and products available for purchase. Examples of such products include goods (e.g., automobiles or computers), services (e.g., cellular telephone services or transportation services), or electronic media (e.g., digital books or digital movies).

Financial investors often research published information to help make investment decisions regarding investment funds. Such published information may include factual information that describes facts (e.g., strategies, managers, or statistical results) about investment funds, evaluative information that describes opinions (e.g., human judgments) about investment funds, or some suitable combination thereof. To help in choosing between multiple investment funds based on such published information, the investor may compare the descriptions of investment funds to his investment values, goals, or preferences. For example, the investor may desire to find an investment fund that aligns with his levels of desired growth and risk tolerance. However, sometimes an investor may be unable to reach a firm decision, despite having considered large amounts of (e.g., all) published information. For example, multiple investment funds may seem to fit all the criteria that the investor is consciously using, but the investor may have an insufficient amount of capital to invest in all of these criteria-satisfying investment funds. In such a situation, the investor may decide to “go with his gut” and accordingly choose one or more investment funds based on personal intuition (e.g., funds that the investor feels most comfortable with). At least initially, the investor may not be able to explain rationally why one investment fund was chosen over another.

A machine (e.g., a computer) may be configured (e.g., by one or more software modules) to fully or partially perform or otherwise facilitate assessment of a user's unconscious preference for one investment alternative (e.g., a first investment alternative) over another investment alternative (e.g., a second investment alternative). Configured as described herein, the machine may form all or part of an intuitive preference assessment tool that provides one or more services (e.g., generation and provision of a report) to help the user determine his or her true preference between at least two investment alternatives (e.g., investment options), for example, when the user has trouble rationally (e.g., intellectually) deciding between at least two seemingly equal investment alternatives. The machine may thus help reveal the user's unconscious preferences (e.g., subconscious bias or other non-conscious preferences) for or against one or more investment alternatives, which may help confirm which investment alternative aligns best with the user's conscious investment goals or conscious investment preferences (e.g., investment preferences of which the user is consciously aware).

The machine may be configured to automatically generate an assessment (e.g., test) for discovering (e.g., diagnosing or otherwise revealing) unconscious preferences of the user regarding two or more investment funds, administer the assessment to the user, analyze submissions received from the user, determine what is the user's unconscious preference (e.g., true preference of which the user is not consciously aware) between or among the investment funds, and generate a report (e.g., a statement, notification, or other output of the assessment) on the user's unconscious preference for one investment fund over one or more other investment funds. In some example embodiments, the machine may generate the assessment in a format or style consistent with an implicit association test (IAT).

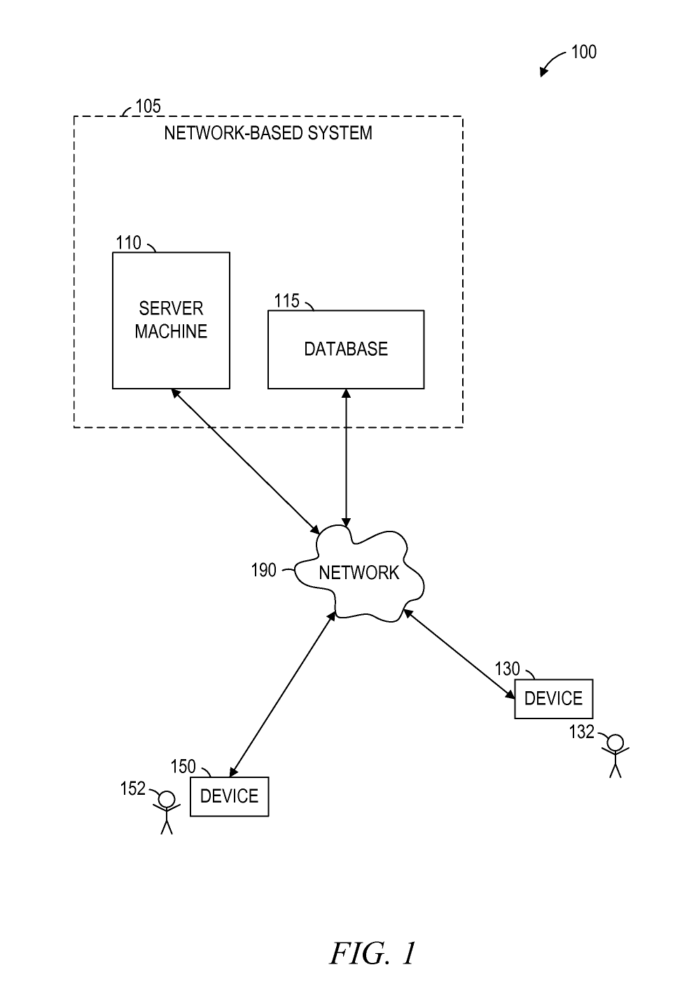

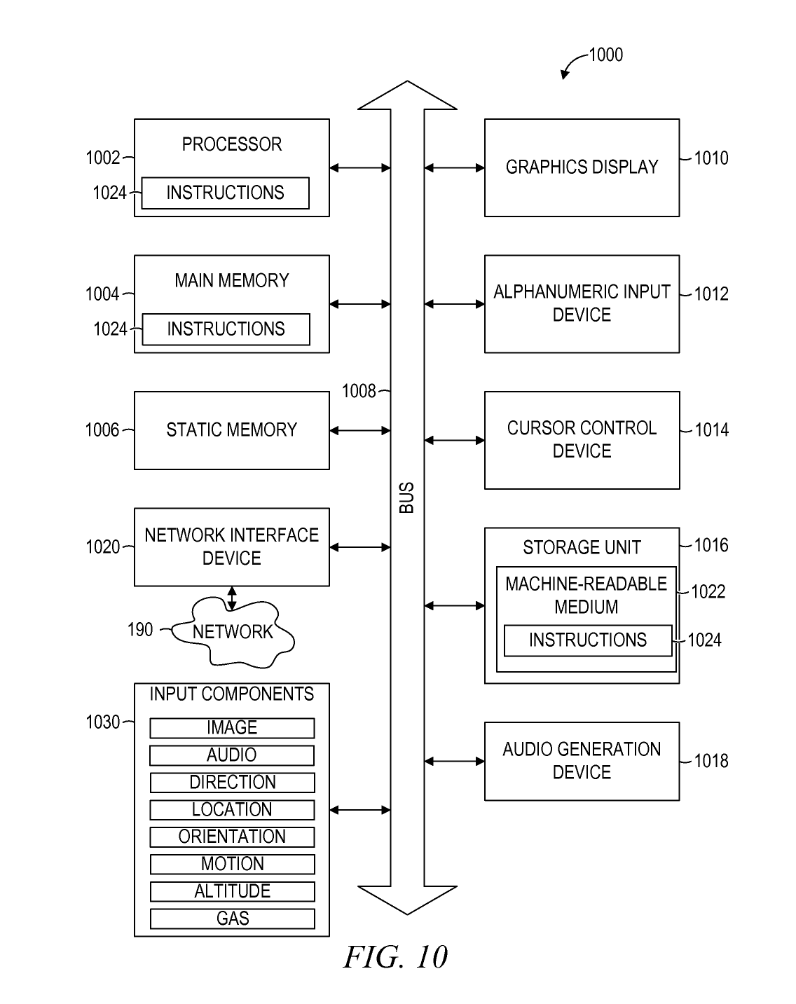

FIG. 1 is a network diagram illustrating a network environment 100 suitable for facilitating preference assessment (e.g., assessment of unconscious preferences) for decision alternatives, according to some example embodiments. The network environment 100 includes a server machine 110, a database 115, and devices 130 and 150, all communicatively coupled to each other via a network 190. The server machine 110 may form all or part of a network-based system 105 (e.g., a cloud-based server system configured to provide one or more services to the devices 130 and 150). The server machine 110 and the devices 130 and 150 may each be implemented in a computer system, in whole or in part, as described below with respect to FIG. 10. The database 115 may store (e.g., permanently or temporarily) any information used by the server machine 110, submitted from the device 130, submitted from the device 150, or any suitable combination thereof, as well as provide access to such stored information.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

Any of the machines, databases, or devices shown in FIG. 1 may be implemented in a special-purpose computer that has been modified (e.g., configured or programmed) by software (e.g., one or more software modules) to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

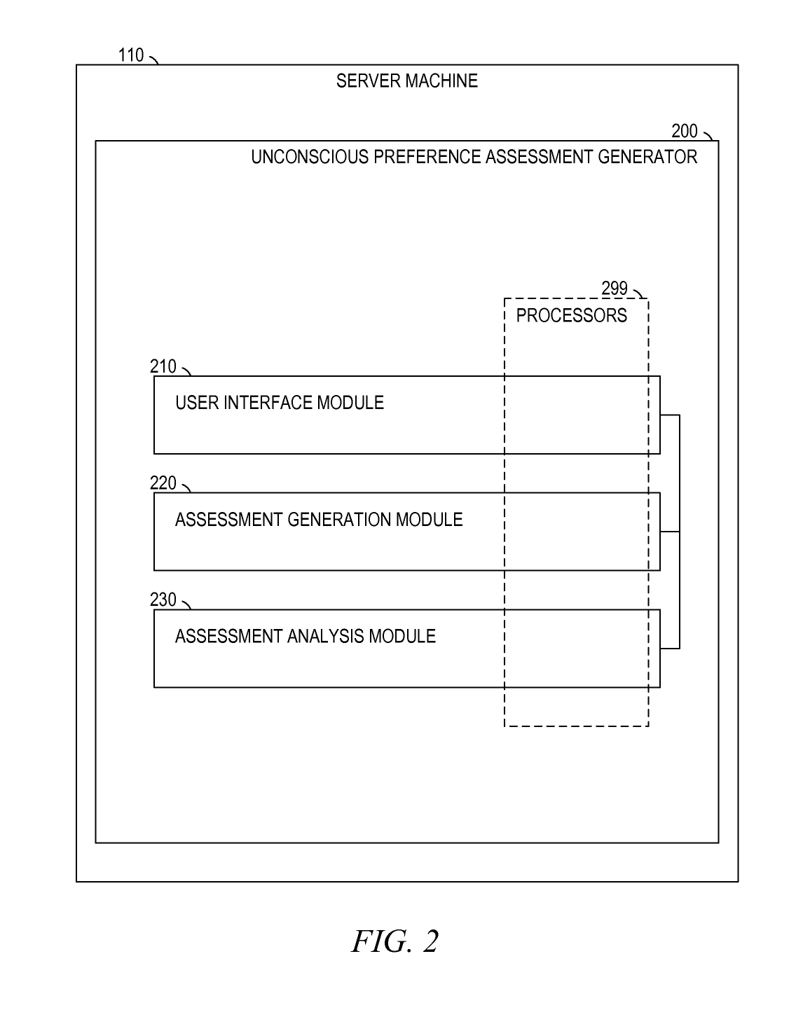

FIG. 2 is a block diagram illustrating components of the server machine 110, according to some example embodiments. The server machine 110 is shown as including an unconscious preference assessment generator 200 (e.g., an intuitive preference assessment generation tool), a user interface module 210, assessment generation module 220, and an assessment analysis module 230, all configured to communicate with each other (e.g., via a bus, shared memory, or a switch).

The user interface module 210 may be configured to generate a user interface (e.g., a graphical user interface (GUI)) and cause the user interface to be displayed by the device 130, the device 150, or both. Displayed by the device 130, the user interface may prompt the user 132 to submit information (e.g., descriptors) via the user interface, and the user interface may communicate prompted submissions from the device 130 to the user interface module 210, which may receive such submissions on behalf of the server machine 110.

The assessment generation module 220 may be configured to generate an assessment (e.g., an assessment of unconscious preferences regarding investment alternatives) based on information obtained by the user interface module 210. The generated assessment may take the example form of one or more screens to be displayed in the user interface and to be operated by the user 132 to submit additional information to the user interface module 210. The assessment generation module 220 may be further configured to administer the assessment to the user 132, for example, by causing the user interface to display (e.g., in a certain sequence) one or more of such screens to prompt the user 132 to submit such additional information (e.g., an assignment of a descriptor to an area or region of each screen) to the user interface module 210.

The assessment analysis module 230 may be configured to analyze the additional information received by the user interface module 210 and generate a report that indicates one or more unconscious preferences held by the user 132. For example, the report may indicate that the user 132 has an unconscious preference for one of the investment alternatives over other investment alternatives. The generated report may be provided by the assessment analysis module 230 to the device 130 for presentation to the user 132.

Any one or more of the modules described herein may be implemented using hardware alone (e.g., one or more processors 299 of a machine) or a combination of hardware and software. For example, any module described herein may physically include an arrangement of one or more processors 299 (e.g., a subset of or among the one or more processors of the machine) configured to perform the operations described herein for that module. As another example, any module described herein may include software, hardware, or both, that configure an arrangement of one or more processors 299 (e.g., among the one or more processors of the machine) to perform the operations described herein for that module. Accordingly, different modules described herein may include and configure different arrangements of such processors 299 or a single arrangement of such processors 299 at different points in time. Moreover, any two or more modules described herein may be combined into a single module, and the functions described herein for a single module may be subdivided among multiple modules. Furthermore, according to various example embodiments, modules described herein as being implemented within a single machine, database, or device may be distributed across multiple machines, databases, or devices.

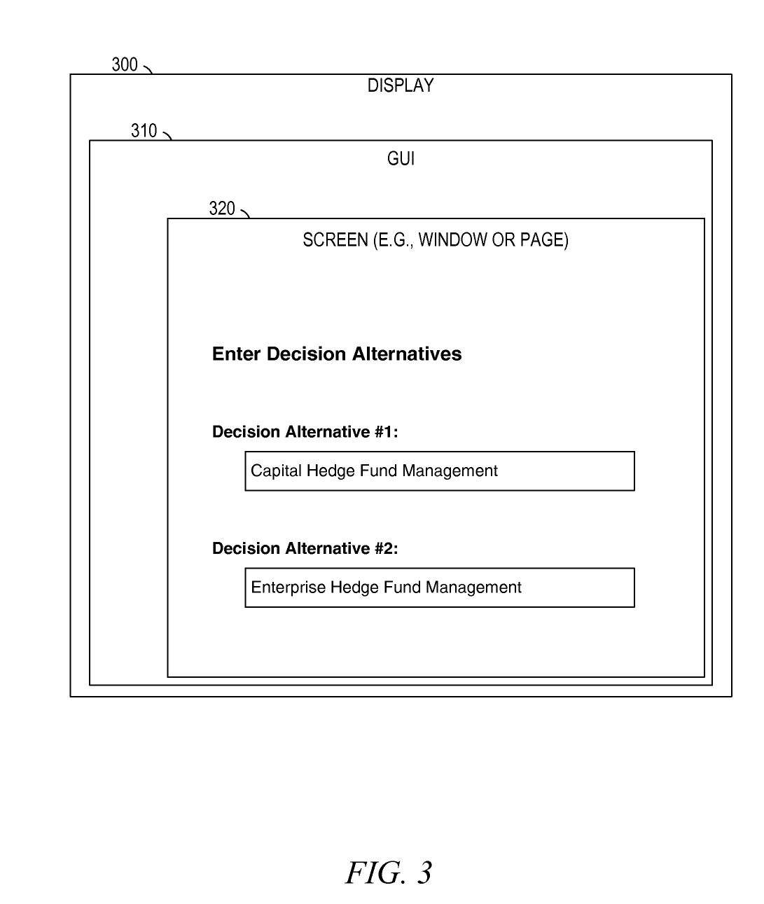

FIG. 3 is a block diagram illustrating a display 300 (e.g., included in the device 130 or connected thereto) with a user interface 310 (e.g., a GUI) that is suitable for preference assessment (e.g., assessment of unconscious preferences), according to some example embodiments. As shown, the user interface 310 includes a screen 320 that prompts the user 132 to enter at least two identifiers of investment alternatives (e.g., as decision alternatives). The screen 320 may be or include a GUI window, a page of a website (e.g., a dynamically generated page), or any suitable combination thereof. FIG. 3 shows text entry fields (e.g., text entry boxes) in which the user 132 may enter and submit a first identifier of a first investment alternative (e.g., “Capital Hedge Fund Management”) and a second identifier of a second investment alternative (e.g., “Enterprise Hedge Fund Management”).

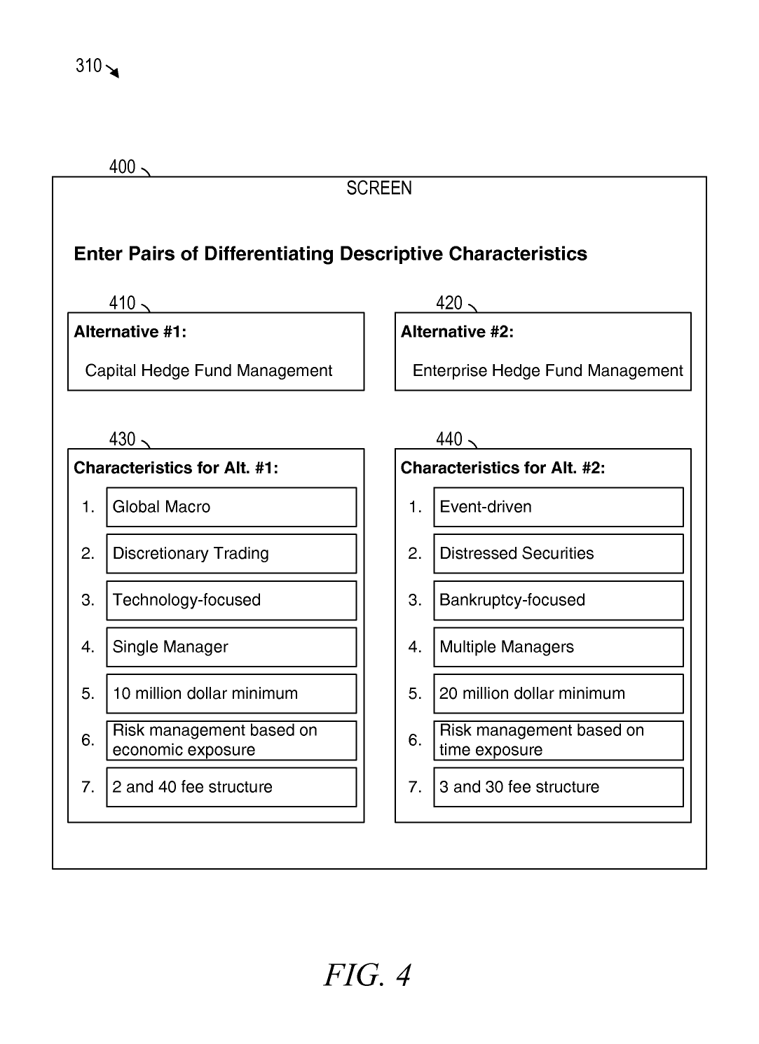

FIG. 4 is a block diagram illustrating a screen 400 of the user interface 310, according to some example embodiments. The screen 400 prompts the user 132 to enter factual descriptors that differentiate the two investment alternatives. As used herein, a “factual descriptor” of an investment alternative is a descriptor that specifies a fact that describes the investment alternative, in contrast with an “evaluative descriptor” of the investment alternative that specifies an opinion regarding the investment alternative.

As shown, the screen 400 enables and instructs the user 132 to enter and submit two sets of factual descriptors, for example, in the form of descriptor pairs (e.g., enumerated pairs of corresponding descriptors). Box 410 depicts the submitted first identifier as corresponding to (e.g., identifying) the first investment alternative, and box 420 depicts the submitted second identifier as corresponding to the second investment alternative. Box 430 prompts and enables the user 132 to enter a first set of factual descriptors for the first investment alternative (e.g., “Capital Hedge Fund Management”), while box 440 props and enables the user 132 to enter a second set of factual descriptors for the second investment alternative (e.g., “Enterprise Hedge Fund Management”).

In the example embodiments illustrated by FIG. 4, as denoted by the numeral “1,” the user 132 has entered the descriptor pair “Global Macro” and “Event-driven” as a first pair of differentiating factual descriptors that distinguish between the two investment alternatives. That is, according to some example embodiments, a factual descriptor in a descriptor pair describes one (e.g., exactly one) of the investment alternatives being considered and not the other investment alternative being considered. Thus, a descriptor pair may be a pair of contrasting descriptors for a same type of trait (e.g., different text strings for location, different text strings for industrial focus, different numerical values for number of managers, or different monetary values for minimum investment amount). Other pairs of differentiating factual descriptors shown in FIG. 4 are “Discretionary Trading” versus “Distressed Securities,” “Technology-focused” versus “Bankruptcy-focused,” “Single Manager” versus “Multiple Managers,” “10 million dollar minimum” versus “20 million dollar minimum,” “Risk management based on economic exposure” versus “Risk management based on time exposure,” and “2 and 20 fee structure” versus “3 and 30 fee structure.”

According to certain example embodiments, more than two investment alternatives are considered simultaneously. For example, if three investment alternatives are being considered, the screen 400 may enable and instruct the user 132 to enter and submit three sets of factual descriptors in the form of descriptor trios (e.g., three factual descriptors for same type of trait, where each factual descriptor describes a different one of the three investment alternatives). In some of these example embodiments, a factual descriptor in a descriptor trio may uniquely describe exactly one investment alternative among the three investment alternatives, thus distinguishing that investment alternative from the other two investment alternatives. In alternative example embodiments, a factual descriptor in a descriptor trio may apply to two investment alternatives among the three investment alternatives, thus distinguishing the remaining investment alternative (e.g., by lacking the factual descriptor). Similarly, if four investment alternatives are to be considered, descriptor quartets may be used as described above for descriptor pairs and descriptor trios. Likewise, any number of multiple investment alternatives may be considered (e.g., in a round-robin arrangement of tests), according to the systems and methods described herein.

In the example embodiments illustrated by FIG. 4, the user 132 has entered seven pairs of factual descriptors, in two sets (e.g., a first set in box 430, and a second set in box 440) for the displayed first and second identifiers. In alternative example embodiments, the user interface module 210 is configured to retrieve one or more of such factual descriptors (e.g., stored in the database 115 or a third party data source) and pre-populate one or more of the seven pairs in the boxes 430 and 440 (e.g., as one or more suggestions for the user 132).

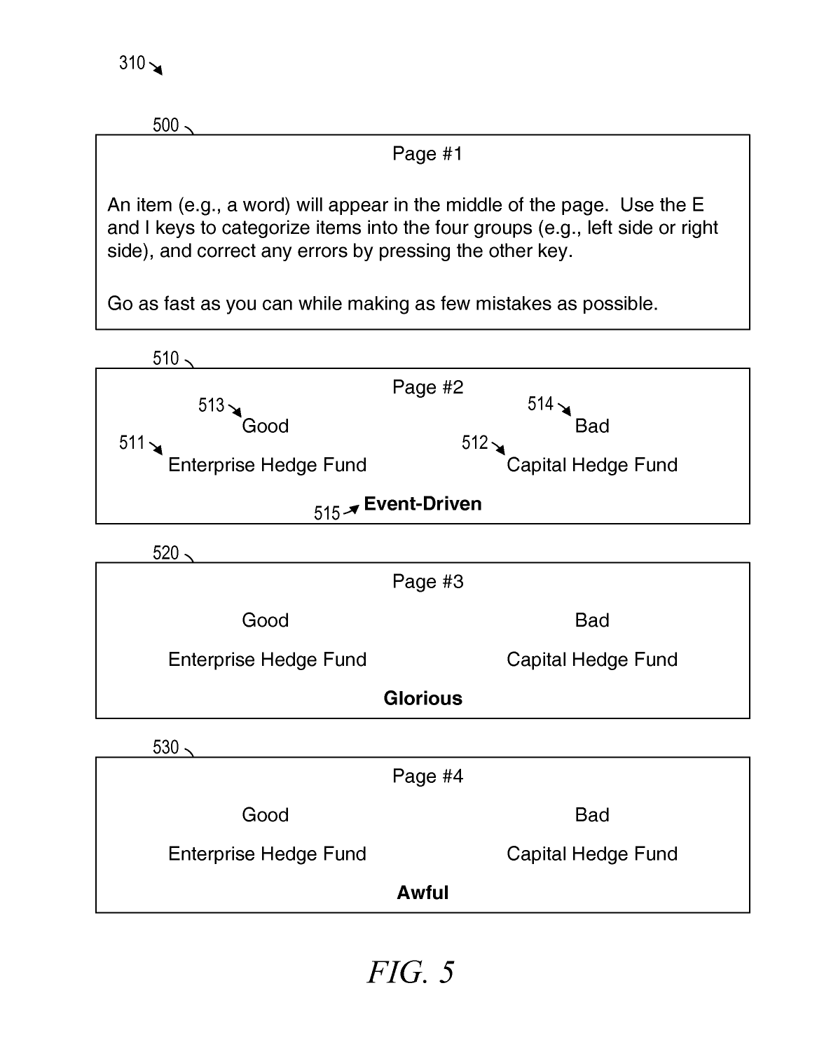

FIG. 5 is a block diagram illustrating screens 500, 510, 520, and 530 of the user interface 310, according to some example embodiments. After receiving information submitted via the screen 400, the screens 500, 510, 520, and 530 may be generated by the assessment generation module 220 based on the received information, for example, as all or part of generating an assessment (e.g., test) of unconscious preferences held by the user 132. As shown, the screen 500 depicts an example set of instructions for operating the assessment (e.g., taking the test). As stated in the example set of instructions, the two submitted decision alternatives will be displayed below two words (e.g., an evaluative descriptor and its opposite) that indicate opinion (e.g., judgment or preference). In the example embodiments illustrated by FIG. 5, the words that indicate opinion are a pair of evaluative descriptors that indicate “good” versus “bad.” Other examples of suitable pairs of evaluative descriptors include “wanted” versus “rejected,” “preferred” versus “non-preferred,” “in” versus “out,” “like” versus “dislike,” and “yes” versus “no.”

In some example embodiments, the set of instructions in the screen 500 direct the user 132 to categorize items (e.g., words) that appear in the middle of each screen into one of multiple areas or regions of each screen. In the example embodiments illustrated by FIG. 5, the screen 510 includes a first area 511 that depicts the first identifier of the first investment alternative (e.g., “Enterprise Hedge Fund [Management]”), a second area 512 that depicts the second identifier of the second investment alternative (e.g., “Capital Hedge Fund [Management]”), a third area 513 that depicts an evaluative descriptor (e.g., “Good”), and a fourth area 514 that depicts an opposite descriptor (e.g., “Bad”) of the evaluative descriptor. As shown, the first area 511 and the third area 513 may be adjacent to each other and may visually pair the evaluation descriptor (e.g., “Good”) with the first identifier (e.g., “Enterprise Hedge Fund [Management]”), thus forming all or part of a first region (e.g., left region or left side) of the screen 510. Likewise, the second area 512 and the fourth area 514 may be adjacent to each other and may visually pair the opposite descriptor (e.g., “Bad”) with the second identifier (e.g., “Capital Hedge Fund [Management]”), thus forming all or part of a second region (e.g., right regional right side) of the screen 510.

A factual descriptor 515 (e.g., one of the factual descriptors discussed above with respect to FIG. 4) appears in a visually central or otherwise visually neutral portion of the screen 510 (e.g., bottom middle of the screen 510). Accordingly, the screen 510 may prompt and enable the user 132 to assign its factual descriptor 515 to one of two regions of the screen 510 (e.g., by pressing an “e” key on a keyboard to select the left region for assignment, or by pressing an “i” key on the keyboard to select the right region for assignment). In alternative example embodiments, the screen 510 may prompt and enable the user 132 to assign the factual descriptor 515 to one of the four areas 511, 512, 513, or 514 of the screen 510 (e.g., by pressing a key that corresponds to the selected area). The reaction time between the displaying of the screen 510 and the assignment of the factual descriptor 515 may be measured (e.g., by the assessment generation module 220) during administration of the assessment, and this reaction time may form a basis for generating and providing a report on the unconscious preferences of the user 132.

In response to the user 132 assigning the factual descriptor 515 to a region (e.g., left region) or area (e.g., first area 511) of the screen 510, the screen 510 may provide feedback. This feedback may be or include an indication that the assignment was erroneous (e.g., displaying a red “X” or other error alert). In such example embodiments, the screen 510 may enable the user 132 to correct such an error by making a second assignment or a second attempt at the assignment. According to various example embodiments, the error rates of the user 132 and the reaction times for making corrections to those errors may be measured by the assessment generation module 220, for use by the assessment analysis module 230.

Each of the other screens 520 and 530 may be configured similarly to the screen 510. According to various example embodiments, any number of similar screens may be generated and displayed as part of an assessment of preferences (e.g., unconscious preferences) held by the user 132. For example, one or more additional screens may each include a different predetermined descriptor (e.g., “happy,” “glorious,” or “awful,” instead of one of the factual descriptors obtained from the user 132) and enable the user 132 to assign (e.g., categorize) the predetermined descriptor into the same regions or areas of the screen. A screen with a predetermined descriptor may be generated and administered as a calibration screen to determine (e.g., measure) how quickly and accurately the user 132 naturally performs the kind of assessment prompted and enabled by the actual screens of the assessment (e.g., screen 510), as well as to enable the user 132 to become familiar with the format of the assessment. One or more calibration screens may be inserted anywhere within the assessment (e.g., prior to the screen 500 or the screen 510; interspersed among the screens 500, 510, 520, 530, 600, 610, 620, and 630; or after the screen 630). As noted above, a screen with a predetermined descriptor may provide feedback to indicate that an assignment was erroneous, and the screen may enable the user 132 to correct mistakes. The reaction time between the displaying of this screen and the assignment of the predetermined descriptor may be measured (e.g., by the assessment generation module 220) during administration of the assessment, for example, to calibrate the assessment.

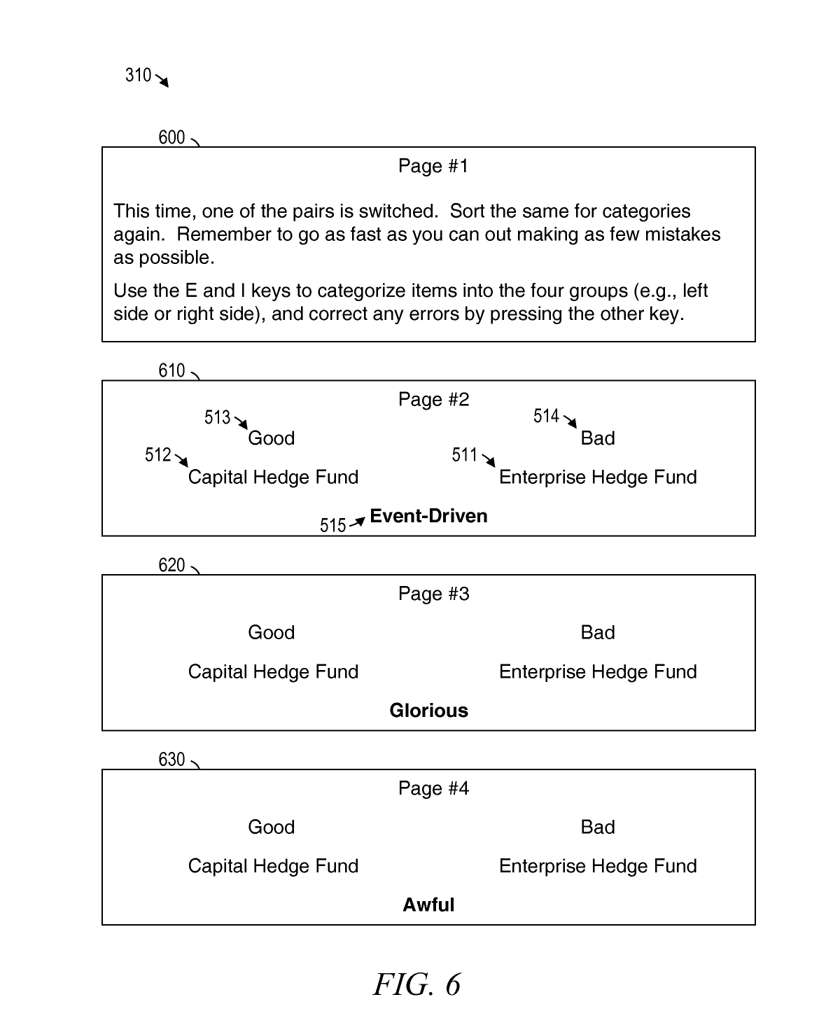

FIG. 6 is a block diagram illustrating screens 600, 610, 620, and 630 of the user interface 310, according to some example embodiments. The screens 600, 610, 620, and 630 are configured similarly to their respective counterparts in FIG. 5, namely, the screens 500, 510, 520, and 530. However, the first and second investment alternatives have now switched places. Thus, in the screen 610, the second area 512 and the third area 513 may now be adjacent to each other and may visually pair the evaluation descriptor (e.g., “Good”) with the second identifier (e.g., “Capital Hedge Fund [Management]”), thus forming all or part of a first region (e.g., left region or left side) of the screen 510. Likewise, the first area 511 and the fourth area 514 may now be adjacent to each other and may visually pair the opposite descriptor (e.g., “Bad”) with the first identifier (e.g., “Enterprise Hedge Fund [Management]”), thus forming all or part of a second region (e.g., right regional right side) of the screen 510.

As noted above, in response to the user 132 assigning the factual descriptor 515 to a region (e.g., left region) or area (e.g., first area 511) of the screen 610, the screen 610 may provide feedback. This feedback may be or include an indication that the assignment was erroneous (e.g., displaying a red “X” or other error alert). In such example embodiments, the screen 610 may enable the user 132 to correct such an error by making a second assignment or a second attempt at the assignment. According to various example embodiments, the error rates of the user 132 and the reaction times for making corrections to those errors may be measured by the assessment generation module 220, for use by the assessment analysis module 230.

Each of the other screens 620 and 630 may be configured similarly to the screen 610. According to various example embodiments, any number of similar screens may be generated and displayed as part of the assessment of preferences (e.g., unconscious preferences) held by the user 132. As noted above, one or more additional screens may each include a different predetermined descriptor (e.g., “awful,” instead of one of the factual descriptors obtained from the user 132) and enable the user 132 to assign the predetermined descriptor into the same regions or areas of the screen. A screen with a predetermined descriptor may be generated and administered as a calibration screen (e.g., for insertion anywhere among the other screens of the assessment). A screen with a predetermined descriptor may provide feedback to indicate that an assignment was erroneous, and the screen may enable the user 132 to correct mistakes. The reaction time between the displaying of this screen and the assignment of the predetermined descriptor may be measured (e.g., by the assessment generation module 220) during administration of the assessment, for example, to calibrate the assessment.

In administering the assessment for unconscious preferences, the assessment generation module 220 may generate and present a sequence of various screens as described above with respect to FIGS. 5 and 6. Moreover, the assessment generation module 220 may randomize some or all of the screens, dynamically adjust the number of screens to be presented to the user 132, or both. Furthermore, such dynamic adjustments may be based on how many errors (e.g., when seeing a particular screen for the first time) the user 132 made in attempting to assign (e.g., categorize) the various items (e.g., factual descriptors, predetermined descriptors, or any suitable combination thereof) displayed in the screens of the assessment.

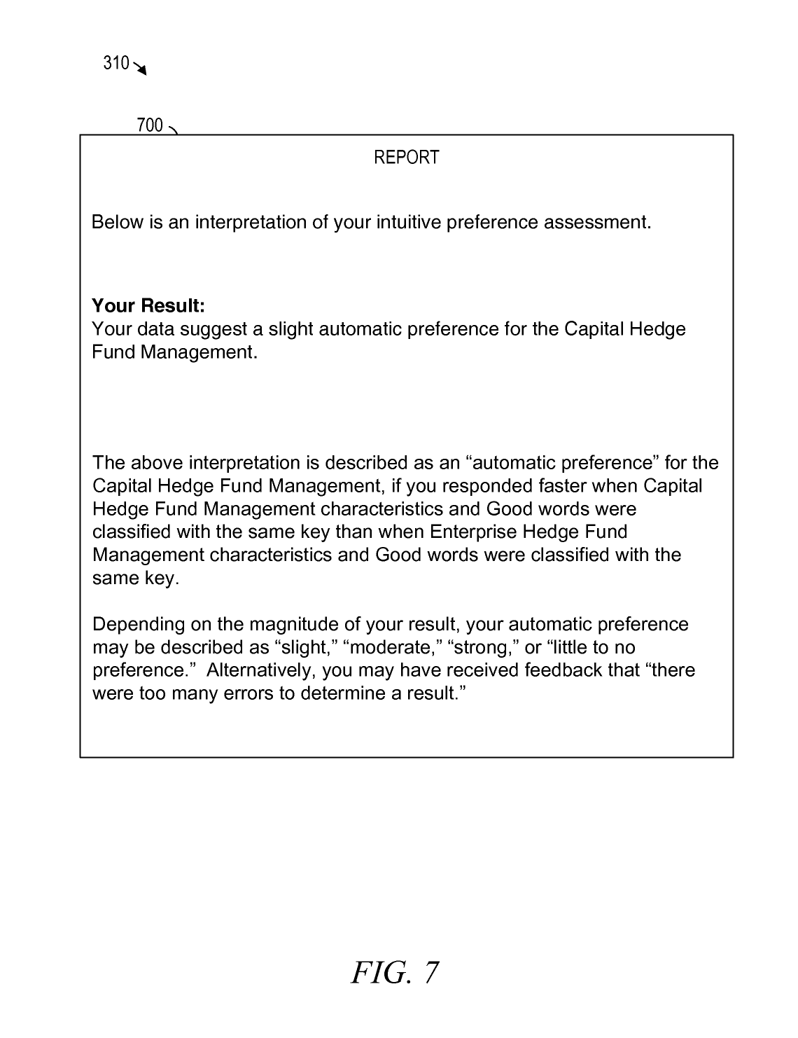

FIG. 7 is a block diagram illustrating a screen of the user interface 310 depicting a report 700 generated from a preference assessment (e.g., an assessment of unconscious preferences), according to some example embodiments. After the user 132 is finished assigning (e.g., categorizing) the items displayed in the screens of the assessment, the assessment analysis module 230 analyzes the assignments (e.g., with their respective reaction times, error rates, correction times, or any suitable combination thereof) and generates the report 700. The report 700 may be or include a statement that reveals and unconscious preference of the user 132 favoring one of the investment alternatives (e.g., over the other investment alternative). As shown in FIG. 7, the report 700 may indicate that the user 132 has a slight automatic preference for the first investment alternative (e.g., “Capital Hedge Fund Management”).

As previously mentioned, the analysis for generating the report 700 may be based on the reaction times between the displaying of each screen (e.g., screen 510) and the assigning of its corresponding item (e.g., factual descriptor 515 or a predetermined descriptor) to a region (e.g., left region) or area (e.g., area 511 or area 513) of that screen. For example, if the user 132 was faster in assigning items to a region or area with a positive sentiment (e.g., with a positive evaluative descriptor, such as “good”) visually paired with the first identifier, compared to assigning items to a region or area with the negative sentiment (e.g., with a negative evaluative descriptor, such as “bad”) visually paired with a first identifier, this difference in reaction times may indicate a stronger preference for the first investment alternative, which is identified by the first identifier.

According to various example embodiments, the analysis for generating the report 700 may be further based on error rates of the user 132 in attempting to assign (e.g., categorize) one or more displayed items (e.g., factual descriptors or predetermined descriptors). For example, if the user 132 made fewer errors in assigning items to a region or area that visually pairs a positive sentiment with the first identifier, in comparison to errors made in assigning items to a region or area that visually pairs a negative sentiment with the first identifier, this difference in error rate may indicate a stronger preference for the first investment alternative.

In some example embodiments, the analysis for generating the report 700 may be further based on correction times for errors made by the user 132 in attempting to assign one or more displayed descriptors in the screens of the assessment. As an example, if the user 132 took longer to correct mistakes in assigning descriptors to a region or area that visually pairs a positive sentiment with the first identifier, as opposed to mistakes in assigning descriptors to a region or area that visually pairs a negative sentiment with the first identifier, this difference in correction times may indicate a stronger preference for the first investment alternative.

In certain example embodiments, the factual descriptors discussed above with respect to FIG. 4 may be filtered (e.g., by the assessment generation module 220) prior to using one or more of the factual descriptors in generating the assessment. For example, the assessment generation module 220 may reject or suggest alternatives for any submitted descriptor that is evaluative in nature instead of factual in nature. As another example, where a pair of factual descriptors is submitted together (e.g., as a descriptor pair in the screen 400), the assessment generation module 220 may reject the pair for having different numbers of syllables (e.g., beyond a threshold maximum difference), since the user 132 may have an unconscious preference for shorter or longer phrases. Accordingly, the assessment generation module 220 may be or include a natural language processor that, for example, is configured to make such projections, provide suitable suggestions, allow the user 132 to make modifications to any rejected factual descriptor, or any suitable combination thereof.

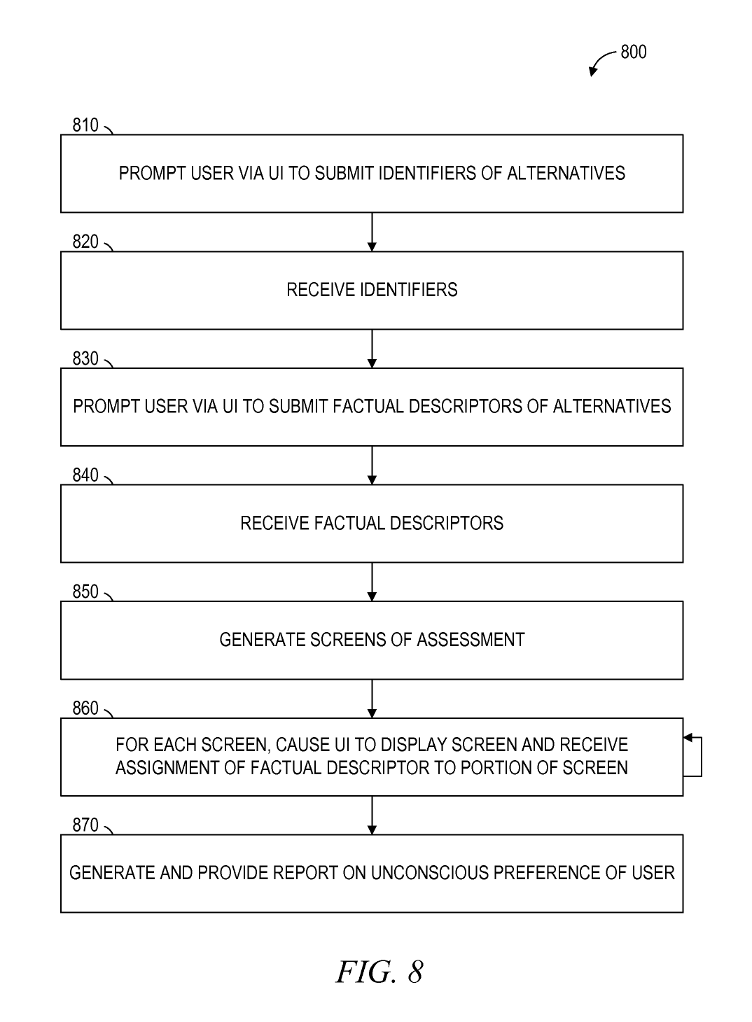

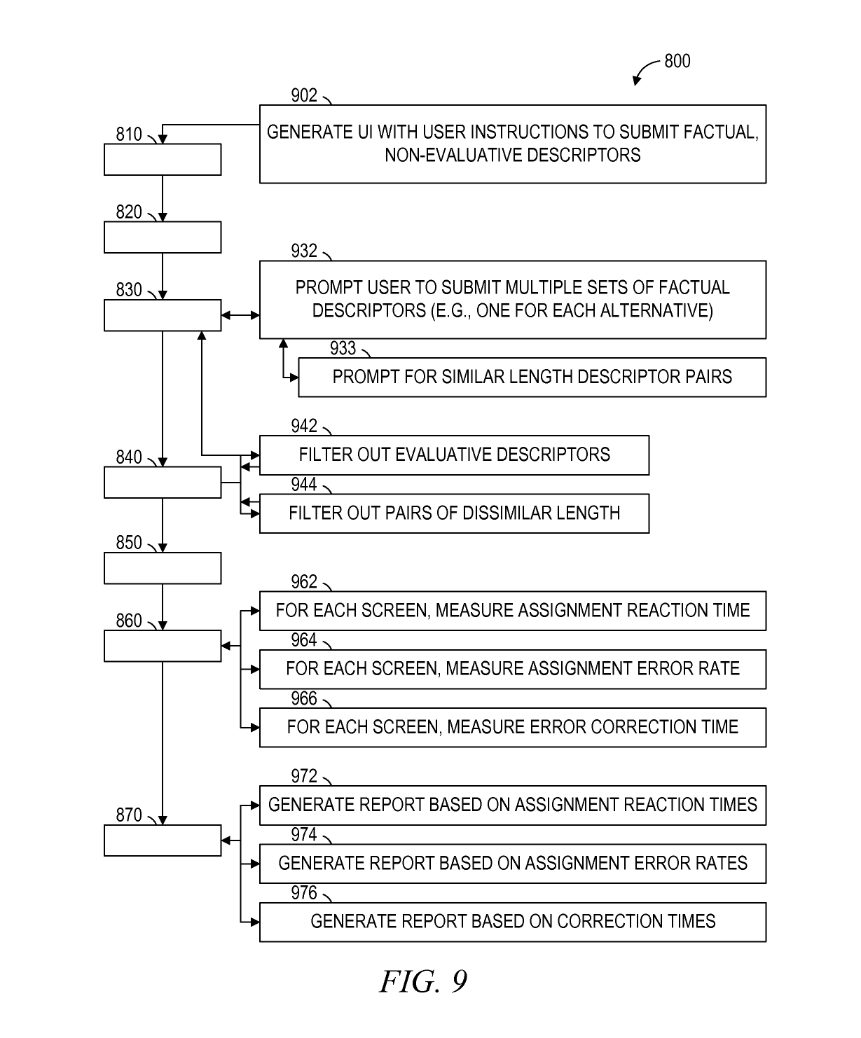

FIGS. 8 and 9 are flowcharts illustrating operations of the server machine 110 in performing a method 800 of performing preference assessment (e.g., assessment of unconscious preferences) for decision alternatives, according to some example embodiments. Operations in the method 800 may be performed using modules described above with respect to FIG. 2. As shown in FIG. 8, the method 800 includes operations 810, 820, 830, 840, 850, 860, and 870.

In operation 810, the user interface module 210 prompts (e.g., requests, instructs, or directs) the user 132 to submit a pair of identifiers of decision alternatives (e.g., investment alternatives) via the user interface 310. The user interface 310 may be displayed to the user 132 by the device 130 (e.g., caused by the user interface module 210 via the network 190). Operation 810 may be fully or partially performed by displaying the screen 320, described above with respect to FIG. 3.

In operation 820, the user interface module 210 receives the prompted and submitted pair of identifiers via the user interface 310. The pair of identifiers includes a first identifier of a first decision alternative (e.g., “Capital Hedge Fund Management”) and a second identifier of a second decision alternative (e.g., “Enterprise Hedge Fund Management”).

In operation 830, the user interface module 210 prompts the user 132 to submit factual descriptors via the user interface 310. As noted above, each of the factual descriptors may specify a fact that uniquely describes exactly one decision alternative in the pair of decision alternatives and not the other decision alternative in the pair. Operation 830 may be fully or partially performed by displaying the screen 400, described above with respect to FIG. 4

In operation 840, the user interface module 210 receives the prompted and submitted factual descriptors via the user interface 310. In some example embodiments, these factual descriptors may be received in multiple sets (e.g., two sets). For example, there may be one set received for each decision alternative. As noted above with respect to FIG. 4, factual descriptors may be received as descriptor tuples (e.g., descriptor pairs, descriptor trios, or descriptor quartets).

In operation 850, the assessment generation module 220 generates the screens 510, 520, 530, 610, 620, and 630 to be displayed in the user interface 310 (e.g., among other screens, including the screens 500 and 600). In some example embodiments, each of the screens 510, 520, 530, 610, 620, and 630 includes at least four areas among which are: a first area (e.g., first area 511) that depicts the first identifier of the first decision alternative (e.g., “Capital Hedge Fund Management”), a second area (e.g., second area 512) that depicts the second identifier of the second decision alternative (e.g., “Enterprise Hedge Fund Management”), a third area (e.g., third area 513) that depicts an evaluative descriptor (e.g., “Good”), and a fourth area (e.g., fourth area 514) that depicts an opposite descriptor (e.g., “Bad”) of the evaluative descriptor. Each of the screens 510, 520, 530, 610, 620, and 630 may enable assignment of a different factual descriptor (e.g., factual descriptor 515) from the received factual descriptors to at least one of the four areas of that screen. In some example embodiments, operation 850 includes generation of one or more calibration screens (e.g., with a corresponding predetermined descriptor, instead of a user-submitted factual descriptor).

In operation 860, for each of the screens 510, 520, 530, 610, 620, and 630, the assessment generation module 220 (e.g., via the user interface module 210) causes the user interface 310 to display that screen (e.g., screen 510) and receive an assignment of the corresponding factual descriptor (e.g., factual descriptor 515) to at least one of the four areas of that screen. In some example embodiments, operation 860 includes causing the user interface 310 to display one or more calibration screens (e.g., with a corresponding predetermined descriptor).

In operation 870, the assessment analysis module 230 generates and provides a report (e.g., report 700) that indicates an unconscious preference by the user 132 for the first decision alternative (e.g., “Capital Hedge Fund Management”) over the second decision alternative (e.g., “Enterprise Hedge Fund Management”). The generating of the report may be based on the assignments received in operation 860 (e.g., among other factors). Once generated, the report may be provided to the device 130 of the user 132 (e.g., via the network 190).

As shown in FIG. 9, the method 800 may include one or more of operations 902, 932, 933, 942, 944, 962, 964, 966, 972, 974, and 976. Operation 902 may be performed prior to operation 830, and FIG. 9 depicts operation 902 being performed prior to operation 810. In operation 902, the user interface module 210 generates the user interface 310. According to certain example embodiments, the user interface 310 may be generated to include an instruction that the user 132 submit the factual descriptors discussed above with respect to operation 830, for example, by specifying facts that distinguish one decision alternative (e.g., “Capital Hedge Fund Management”) of the pair of decision alternatives over another decision alternative (e.g., “Enterprise Hedge Fund Management”) of the pair of decision alternatives. In various example embodiments, the user interface 310 may be generated to include an instruction that the user 132 submit the factual descriptors by submitting non-evaluative descriptors (e.g., avoiding descriptors that contain an opinion, a judgment, or a preference).

Operation 932 may be performed as part (e.g., a precursor task, a subroutine, or a portion) of operation 830, in which the user 132 is prompted to submit the factual descriptors. In operation 932, the user interface module 210 prompts the user 132 to submit multiple sets of factual descriptors, one for each decision alternative. For example, the user 132 may be prompted to submit two sets of factual descriptors, such as a first set of factual descriptors that factually describe the first decision alternative (e.g., “Capital Hedge Fund Management”) and a second set of factual descriptors that actually describe the second decision alternative (e.g., “Enterprise Hedge Fund Management”). As noted above, the user 132 may be prompted to submit these factual descriptors in the form of contrasting pairs of factual descriptors (e.g., “Global Macro” and “Event-driven”).

Operation 933 may be performed as part of operation 932. In operation 933, the user interface module 210 prompts the user 132 to submit factual descriptors (e.g., as descriptor tuples, such as descriptor pairs) that have similar length. In some example embodiments, the user 132 is prompted to submit factual descriptors that have numbers of syllables within a threshold tolerance value (e.g., exactly the same number of syllables, at most one syllable apart, or at most two syllables apart).

One or more of operations 942 and 944 may be performed as part of, or after, operation 840, in which the user interface module 210 receives the factual descriptors submitted by the user 132. In operation 942, the user interface module 210 filters out any evaluative descriptors received in operation 830. As noted above, the user interface module 210 may reject an evaluative descriptor, suggest one or more factual descriptors as alternatives, and allow the user 132 to resubmit the rejected descriptor. In operation 944, the user interface module 210 filters out any descriptor tuples (e.g., descriptor pairs) of dissimilar length. For example, the user interface module 210 may reject a descriptor pair with differing numbers of syllables (e.g., beyond a threshold tolerance value, such as a zero syllable difference, a one syllable difference, or a two syllable difference). As noted above, the user interface module 210 may reject a descriptor pair, suggest one or more factual descriptors as alternatives, and allow the user 132 to resubmit the rejected descriptor pair.

As shown in FIG. 9, one or more of operations 962, 964, and 966 may be performed as part of operation 860, in which the assessment generation module 220 receives the assignments (e.g., categorizations) of the corresponding factual descriptors (e.g., factual descriptor 515) for each of the displayed screens 510, 520, 530, 610, 620, and 630. In operation 962, for each displayed screen (e.g., screen 510), the assessment generation module 220 measures the reaction time between the displaying of the screen and the assignment of its corresponding factual descriptor to a region or area of the screen. For example, the reaction time may be measured between the time that the assessment generation module 220 causes the display of the screen and the time that the assessment generation module 220 receives the assignment of the factual descriptor.

In example embodiments that include operation 962, operation 972 may be performed as part of operation 870, in which the assessment analysis module 230 generates the report 700. In example embodiments that include operation 972, the generation of the report 700 is based on the reaction times measured in operation 962 (e.g., as discussed above with respect to FIG. 7).

In operation 964, for each displayed screen (e.g., screen 510), the assessment generation module 220 measures the error rate of the user 132 in assigning the factual descriptor of that screen to a region or area of the screen. For example, the error rate may be measured as a total error rate (e.g., the number of times that the user 132 incorrectly assigned the factual descriptor). As another example, the error rate may be measured as a first-time error rate (e.g., whether the user 132 incorrectly assigned the factual descriptor when presented with that screen for the very first time).

In example embodiments that include operation 964, operation 974 may be performed as part of operation 870, in which the assessment analysis module 230 generates the report 700. In example embodiments that include operation 974, the generation of the report 700 is based on the reaction times measured in operation 964 (as discussed above with respect to FIG. 7).

In operation 966, for each displayed screen (e.g., screen 510), the assessment generation module 220 measures the error correction time of the user 132 in correcting an erroneous assignment of the factual descriptor for that screen to an incorrect region or area of the screen. For example, the error correction time may be measured between the time that the screen provides the user 132 with feedback that indicates an error has been made (e.g., a red “X” icon) and the time that a corrected assignment of the corresponding factual descriptor is received by the assessment generation module 220.

In example embodiments that include operation 966, operation 976 may be performed as part of operation 870, in which the assessment analysis module 230 generates the report 700. In example embodiments that include operation 976, the generation of the report 700 is based on the reaction times measured in operation 966 (as discussed above with respect to FIG. 7).

According to various example embodiments, one or more of the methodologies described herein may facilitate machine-generation and machine-administration of an assessment for unconscious preferences in decision-making. Moreover, the generation and administration of this assessment may be fully or partially user-configured (e.g., user influenced), for example, by the prompting, receiving, and using of user-submitted identifiers of decision alternatives and factual descriptors of those decision alternatives. Accordingly, one or more of the methodologies described herein may facilitate discovery of one or more unconscious preferences held by a user regarding one or more of these decision alternatives. Thus, one or more of the methodologies described herein may facilitate decision-making by that user, as well as facilitate self-discovery or self-awareness by the user.

When these effects are considered in aggregate, one or more of the methodologies described herein may obviate a need for certain efforts or resources that otherwise would be involved in providing one or more machine-generated suggestions or recommendations regarding a choice to be made between decision alternatives. Efforts expended by a user in assessing or analyzing unconscious preferences may be reduced by use of (e.g., reliance upon) a machine that implements one or more of the methodologies described herein. Computing resources used by one or more machines, databases, or devices (e.g., within the network environment 100) may similarly be reduced (e.g., compared to machines, databases, or devices that lack one or more the methodologies described herein). Examples of such computing resources include processor cycles, network traffic, memory usage, data storage capacity, power consumption, and cooling capacity.

FIG. 10 is a block diagram illustrating components of a machine 1000, according to some example embodiments, able to read instructions 1024 from a machine-readable medium 1022 (e.g., a non-transitory machine-readable medium, a machine-readable storage medium, a computer-readable storage medium, or any suitable combination thereof) and perform any one or more of the methodologies discussed herein, in whole or in part. Specifically, FIG. 10 shows the machine 1000 in the example form of a computer system (e.g., a computer) within which the instructions 1024 (e.g., software, a program, an application, an applet, an app, or other executable code) for causing the machine 1000 to perform any one or more of the methodologies discussed herein may be executed, in whole or in part.

In alternative embodiments, the machine 1000 operates as a standalone device or may be communicatively coupled (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The processor 1002 may contain solid-state digital microcircuits (e.g., electronic, optical, or both) that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e.g., software modules) described herein. In some example embodiments, the processor 1002 is a multicore CPU (e.g., a dual-core CPU, a quad-core CPU, or a 128-core CPU) within which each of multiple cores is a separate processor that is able to perform any one or more of the methodologies discussed herein, in whole or in part. Although the beneficial effects described herein may be provided by the machine 1000 with at least the processor 1002, these same effects may be provided by a different kind of machine that contains no processors (e.g., a purely mechanical system, a purely hydraulic system, or a hybrid mechanical-hydraulic system), if such a processor-less machine is configured to perform one or more the methodologies described herein.

The machine 1000 may further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, an audio generation device 1018 (e.g., a sound card, an amplifier, a speaker, a headphone jack, or any suitable combination thereof), and a network interface device 1020.

The storage unit 1016 includes the machine-readable medium 1022 (e.g., a tangible and non-transitory machine-readable storage medium) on which are stored the instructions 1024 embodying any one or more of the methodologies or functions described herein. The instructions 1024 may also reside, completely or at least partially, within the main memory 1004, within the processor 1002 (e.g., within the processor's cache memory), or both, before or during execution thereof by the machine 1000. Accordingly, the main memory 1004 and the processor 1002 may be considered machine-readable media (e.g., tangible and non-transitory machine-readable media). The instructions 1024 may be transmitted or received over the network 190 via the network interface device 1020. For example, the network interface device 1020 may communicate the instructions 1024 using any one or more transfer protocols (e.g., hypertext transfer protocol (HTTP)).

In some example embodiments, the machine 1000 may be a portable computing device, such as a smart phone or tablet computer, and have one or more additional input components 1030 (e.g., sensors or gauges). Examples of such input components 1030 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof. In some example embodiments, the instructions 1024 for execution by the machine 1000 may be carried by a carrier medium. Examples of such a carrier medium include a storage medium and a transient medium (e.g., a signal carrying the instructions 1024).

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a CPU or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a CPU configured by software to become a special-purpose processor, the CPU may be configured as respectively different special-purpose processors (e.g., each included in a different hardware module) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. Accordingly, the operations described herein may be at least partially processor-implemented, since a processor is an example of hardware. For example, at least some operations of any method may be performed by one or more processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated embodiments describe various example embodiments of methods, machine-readable media, and systems (e.g., apparatus) discussed herein.

A first embodiment provides a method comprising:

prompting a user to submit a pair of identifiers of decision alternatives via a user interface displayed to the user;
receiving the pair of identifiers via the user interface, the pair including a first identifier of a first decision alternative and a second identifier of a second decision alternative;
prompting the user to submit factual descriptors via the user interface, each of the factual descriptors specifying a fact that describes exactly one of the pair of decision alternatives;
receiving the factual descriptors via the user interface;
by at least one processor of a machine, generating screens to be displayed in the user interface, each of the screens including four areas among which are: a first area that depicts the first identifier of the first decision alternative, a second area that depicts the second identifier of the second decision alternative, a third area that depicts an evaluative descriptor, and a fourth area that depicts an opposite descriptor of the evaluative descriptor, each of the screens enabling assignment of a different factual descriptor from the received factual descriptors to at least one of the four areas;
for each of the screens, causing the user interface to display the screen and receiving an assignment of the corresponding factual descriptor to at least one of the four areas of the screen; and
by at least one processor of the machine, generating and providing a report that indicates a preference (e.g., an unconscious preference) by the user for the first decision alternative over the second decision alternative, the generating being based on the assignments for each of the screens.

A second embodiment provides a method according to the first embodiment, further comprising:

generating the user interface to include an instruction that the user submit the factual descriptors by specifying facts that distinguish one decision alternative of the pair of decision alternatives over another decision alternative of the pair of decision alternatives.

A third embodiment provides a method according to the first or second embodiment, further comprising:

generating the user interface to include an instruction that the user submit the factual descriptors by submitting non-evaluative descriptors.

A fourth embodiment provides a method according to any of the first through third embodiments, wherein:

the prompting of the user to submit factual descriptors includes prompting the user to submit two sets of factual descriptors, the two sets including a first set of factual descriptors that factually describe the first decision alternative and a second set of factual descriptors that factually describe the second decision alternative.

A fifth embodiment provides a method according to the fourth embodiment, wherein:

the prompting of the user to submit the two sets of factual descriptors includes instructing the user to submit pairs of factual descriptors of similar length, each submitted pair of factual descriptors including a first factual descriptor of the first decision alternative and a second factual descriptor of the second decision alternative.

A sixth embodiment provides a method according to the fourth or fifth embodiment, wherein:

at least one of the generated screens enables assignment of one of the first set of factual descriptors that describe the first decision alternative to the first area that depicts the first identifier of the first decision alternative.

A seventh embodiment provides a method according to any of the fourth through sixth embodiments, wherein:

at least one of the generated screens enables assignment of one of the first set of factual descriptors that describe the first decision alternative to the second area that depicts the second identifier of the second decision alternative.

An eighth embodiment provides a method according to any of the fourth through seventh embodiments, wherein:

at least one of the generated screens enables assignment of one of the first set of factual descriptors that describe the first decision alternative to the third area that depicts the evaluative descriptor.

A ninth embodiment provides a method according to any of the fourth through eighth embodiments, wherein:

at least one of the generated screens enables assignment of one of the first set of factual descriptors that describe the first decision alternative to the fourth area that depicts the opposite descriptor of the evaluative descriptor.

A tenth embodiment provides a method according to any of the first through ninth embodiments, wherein:

in each of the screens, the first area and the third area together form a first region that visually pairs the first identifier of the first decision alternative with the evaluative descriptor, and the second area and the fourth area together form a second region that visually pairs the second identifier of the second decision alternative with the opposite descriptor; and
for each of the screens, the received assignment of the corresponding factual descriptor assigns the factual descriptor to one of the first or second regions of the screen.

An eleventh embodiment provides a method according to the tenth embodiment, wherein:

the evaluative descriptor visually paired with the first identifier of the first decision alternative expresses a positive sentiment; and
the opposite descriptor visually paired with the second identifier of the second decision alternative expresses a negative sentiment.

A twelfth embodiment provides a method according to the tenth or eleventh embodiment, wherein:

the evaluative descriptor visually paired with the first identifier and the opposite descriptor visually paired with the second identifier are selected from a group of descriptor pairs consisting of “good” versus “bad,” “wanted” versus “rejected,” “preferred” versus “non-preferred,” “in” versus “out,” “like” versus “dislike,” and “yes” versus “no.”

A thirteenth embodiment provides a method according to any of the first through twelfth embodiments, further comprising:

for each of the screens, measuring a reaction time from the displaying of the screen to the receiving of the assignment of the corresponding factual descriptor to one of the two areas of the screen; and wherein
the generating of the report that indicates the preference for the first decision alternative is based on the measured reaction times for each of the screens.

A fourteenth embodiment provides a method according to any of the first through thirteenth embodiments, wherein:

the first identifier identifies a first investment fund as the first decision alternative;
the second identifier identifies a second investment fund as the second decision alternative; and
the generated report indicates a preference (e.g., an unconscious preference) by the user for the first investment fund.

A fifteenth embodiment provides a method according to any of the first through fourteenth embodiments, wherein:

the first identifier identifies a first management entity as the first decision alternative;
the second identifier identifies a second management entity as the second decision alternative; and
the generated report indicates a preference (e.g., an unconscious preference) by the user for the first management entity.

A sixteenth embodiment provides a method according to any of the first through fifteenth embodiments, wherein:

the first identifier identifies a first investment strategy as the first decision alternative;
the second identifier identifies a second investment strategy as the second decision alternative; and
the generated report indicates a preference (e.g., an unconscious preference) by the user for the first investment strategy.

A seventeenth embodiment provides a method according to any of the first through sixteenth embodiment, wherein:

the first identifier identifies a first investment termination strategy as the first decision alternative;
the second identifier identifies a second investment termination strategy as the second decision alternative; and
the generated report indicates a preference (e.g., an unconscious preference) by the user for the first investment termination strategy.

An eighteenth embodiment provides a method according to any of the first through seventeenth embodiments, wherein:

the first identifier identifies a first potential business partner as the first decision alternative;
the second identifier identifies a second potential business partner as the second decision alternative; and
the generated report indicates a preference (e.g., an unconscious preference) by the user for the first potential business partner.

A nineteenth embodiment provides a non-transitory machine-readable storage medium comprising instructions that, when executed by one or more processors of a machine, cause the machine to perform operations comprising:

prompting a user to submit a pair of identifiers that identify a pair of decision alternatives via a user interface displayed to the user;
receiving the pair of identifiers via the user interface, the pair including a first identifier of a first decision alternative and a second identifier of a second decision alternative;
prompting the user to submit factual descriptors via the user interface, each of the factual descriptors specifying a fact that describes exactly one of the pair of decision alternatives;
receiving the factual descriptors via the user interface;
by at least one processor of the machine, generating screens to be displayed in the user interface, each of the screens including four areas among which are: a first area that depicts the first identifier of the first decision alternative, a second area that depicts the second identifier of the second decision alternative, a third area that depicts an evaluative descriptor, and a fourth area that depicts an opposite descriptor of the evaluative descriptor, each of the screens enabling assignment of a different factual descriptor from the received factual descriptors to at least one of the four areas;
for each of the screens, causing the user interface to display the screen and receiving an assignment of the corresponding factual descriptor to at least one of the four areas of the screen; and
by at least one processor of the machine, generating and providing a report that indicates a preference (e.g., an unconscious preference) by the user for the first decision alternative over the second decision alternative, the generating being based on the assignments for each of the screens.

A twentieth embodiment provides a non-transitory machine-readable storage medium according to the nineteenth embodiment, wherein:

the first identifier identifies a first potential employee as the first decision alternative;
the second identifier identifies a second potential employee as the second decision alternative; and
the generated report indicates a preference (e.g., an unconscious preference) by the user for the first potential employee.

A twenty first embodiment provides a system comprising:

a user interface module comprising at least one processor and configured to:
prompt a user to submit a pair of identifiers of decision alternatives via a user interface displayed to the user;
receive the pair of identifiers via the user interface, the pair including a first identifier of a first decision alternative and a second identifier of a second decision alternative;
prompt the user to submit factual descriptors via the user interface, each of the factual descriptors specifying a fact that describes exactly one of the pair of decision alternatives; and
receive the factual descriptors via the user interface;
   an assessment generation module comprising at least one processor and configured to generate screens to be displayed in the user interface, each of the screens including four areas among which are: a first area that depicts the first identifier of the first decision alternative, a second area that depicts the second identifier of the second decision alternative, a third area that depicts an evaluative descriptor, and a fourth area that depicts an opposite descriptor of the evaluative descriptor, each of the screens enabling assignment of a different factual descriptor from the received factual descriptors to at least one of the four areas;
   the user interface module being configured to, for each of the screens, cause the user interface to display the screen and receive an assignment of the corresponding factual descriptor to at least one of the four areas of the screen; and
   an assessment analysis module comprising at least one processor and configured to generate and provide a report that indicates a preference (e.g., an unconscious preference) by the user for the first decision alternative over the second decision alternative, the generating being based on the assignments for each of the screens.

A twenty second embodiment provides a system according to the twenty first embodiment, wherein:

the first identifier identifies a first product as the first decision alternative;
the second identifier identifies a second product as the second decision alternative; and
the generated report indicates a preference (e.g., an unconscious preference) by the user for the first product.

A twenty first embodiment provides a carrier medium carrying machine-readable instructions for controlling a machine to carry out the method of any one of the previously described embodiments.

What is claimed is:

1. A method comprising:
prompting a user to submit a pair of identifiers that identify a pair of decision alternatives via a user interface displayed to the user;
receiving the pair of identifiers via the user interface, the pair including a first identifier of a first decision alternative and a second identifier of a second decision alternative;
prompting the user to submit factual descriptors via the user interface, each of the factual descriptors specifying a fact that describes exactly one of the pair of decision alternatives;
receiving the factual descriptors via the user interface;
by at least one processor of a machine, generating screens to be displayed in the user interface, each of the screens including four areas among which are: a first area that depicts the first identifier of the first decision alternative, a second area that depicts the second identifier of the second decision alternative, a third area that depicts an evaluative descriptor, and a fourth area that depicts an opposite descriptor of the evaluative descriptor, each of the screens enabling assignment of a different factual descriptor from the received factual descriptors to at least one of the four areas;
for each of the screens, causing the user interface to display the screen and receiving an assignment of the corresponding factual descriptor to at least one of the four areas of the screen; and
by at least one processor of the machine, generating and providing a report that indicates a preference by the user for the first decision alternative over the second decision alternative, the generating being based on the assignments for each of the screens.

2. The method of claim 1, further comprising:
generating the user interface to include an instruction that the user submit the factual descriptors by specifying facts that distinguish one decision alternative of the pair of decision alternatives over another decision alternative of the pair of decision alternatives.

3. The method of claim 1, further comprising:
generating the user interface to include an instruction that the user submit the factual descriptors by submitting non-evaluative descriptors.

4. The method of claim 1, wherein:
the prompting of the user to submit factual descriptors includes prompting the user to submit two sets of factual descriptors, the two sets including a first set of factual descriptors that factually describe the first decision alternative and a second set of factual descriptors that factually describe the second decision alternative.

5. The method of claim 4, wherein:
the prompting of the user to submit the two sets of factual descriptors includes instructing the user to submit pairs of factual descriptors of similar length, each submitted pair of factual descriptors including a first factual descriptor of the first decision alternative and a second factual descriptor of the second decision alternative.

6. The method of claim 4, wherein:
at least one of the generated screens enables assignment of one of the first set of factual descriptors that describe the first decision alternative to the first area that depicts the first identifier of the first decision alternative.

7. The method of claim 4, wherein:
at least one of the generated screens enables assignment of one of the first set of factual descriptors that describe the first decision alternative to the second area that depicts the second identifier of the second decision alternative.

8. The method of claim 4, wherein:
at least one of the generated screens enables assignment of one of the first set of factual descriptors that describe the first decision alternative to the third area that depicts the evaluative descriptor.

9. The method of claim 4, wherein:
at least one of the generated screens enables assignment of one of the first set of factual descriptors that describe the first decision alternative to the fourth area that depicts the opposite descriptor of the evaluative descriptor.

10. The method of claim 1, wherein:
in each of the screens, the first area and the third area together form a first region that visually pairs the first identifier of the first decision alternative with the evaluative descriptor, and the second area and the fourth area together form a second region that visually pairs the second identifier of the second decision alternative with the opposite descriptor; and
for each of the screens, the received assignment of the corresponding factual descriptor assigns the factual descriptor to one of the first or second regions of the screen.

11. The method of claim 10, wherein:
the evaluative descriptor visually paired with the first identifier of the first decision alternative expresses a positive sentiment; and
the opposite descriptor visually paired with the second identifier of the second decision alternative expresses a negative sentiment.

12. The method of claim 10, wherein:
the evaluative descriptor visually paired with the first identifier and the opposite descriptor visually paired with the second identifier are selected from a group of descriptor pairs consisting of “good” versus “bad,” “wanted” versus “rejected,” “preferred” versus “non-preferred,” “in” versus “out,” “like” versus “dislike,” and “yes” versus “no.”

13. The method of claim 1, further comprising:
for each of the screens, measuring a reaction time from the displaying of the screen to the receiving of the assignment of the corresponding factual descriptor to one of the two areas of the screen; and wherein
the generating of the report that indicates the preference for the first decision alternative is based on the measured reaction times for each of the screens.

14. The method of claim 1, wherein:
the first identifier identifies a first investment fund as the first decision alternative;
the second identifier identifies a second investment fund as the second decision alternative; and
the generated report indicates a preference by the user for the first investment fund.

15. The method of claim 1, wherein:
the first identifier identifies a first management entity as the first decision alternative;
the second identifier identifies a second management entity as the second decision alternative; and
the generated report indicates a preference by the user for the first management entity.

16. The method of claim 1, wherein:
the first identifier identifies a first investment strategy as the first decision alternative;
the second identifier identifies a second investment strategy as the second decision alternative; and
the generated report indicates a preference by the user for the first investment strategy.

17. The method of claim 1, wherein:
the first identifier identifies a first investment termination strategy as the first decision alternative;
the second identifier identifies a second investment termination strategy as the second decision alternative; and
the generated report indicates a preference by the user for the first investment termination strategy.

18. The method of claim 1, wherein:
the first identifier identifies a first potential business partner as the first decision alternative;
the second identifier identifies a second potential business partner as the second decision alternative; and
the generated report indicates a preference by the user for the first potential business partner.

19. A non-transitory machine-readable storage medium comprising instructions that, when executed by one or more processors of a machine, cause the machine to perform operations comprising:
prompting a user to submit a pair of identifiers that identify a pair of decision alternatives via a user interface displayed to the user;
receiving the pair of identifiers via the user interface, the pair including a first identifier of a first decision alternative and a second identifier of a second decision alternative;
prompting the user to submit factual descriptors via the user interface, each of the factual descriptors specifying a fact that describes exactly one of the pair of decision alternatives;
receiving the factual descriptors via the user interface;
by at least one processor of the machine, generating screens to be displayed in the user interface, each of the screens including four areas among which are: a first area that depicts the first identifier of the first decision alternative, a second area that depicts the second identifier of the second decision alternative, a third area that depicts an evaluative descriptor, and a fourth area that depicts an opposite descriptor of the evaluative descriptor, each of the screens enabling assignment of a different factual descriptor from the received factual descriptors to at least one of the four areas;
for each of the screens, causing the user interface to display the screen and receiving an assignment of the corresponding factual descriptor to at least one of the four areas of the screen; and
by at least one processor of the machine, generating and providing a report that indicates a preference by the user for the first decision alternative over the second decision alternative, the generating being based on the assignments for each of the screens.

20. The non-transitory machine-readable storage medium of claim 19, wherein:
the first identifier identifies a first potential employee as the first decision alternative;
the second identifier identifies a second potential employee as the second decision alternative; and
the generated report indicates a preference by the user for the first potential employee.

21. A system comprising:
a user interface module comprising at least one processor and configured to:
prompt a user to submit a pair of identifiers that identify a pair of decision alternatives via a user interface displayed to the user;
receive the pair of identifiers via the user interface, the pair including a first identifier of a first decision alternative and a second identifier of a second decision alternative;
prompt the user to submit factual descriptors via the user interface, each of the factual descriptors specifying a fact that describes exactly one of the pair of decision alternatives; and
receive the factual descriptors via the user interface;
an assessment generation module comprising at least one processor and configured to generate screens to be displayed in the user interface, each of the screens including four areas among which are: a first area that depicts the first identifier of the first decision alternative, a second area that depicts the second identifier of the second decision alternative, a third area that depicts an evaluative descriptor, and a fourth area that depicts an opposite descriptor of the evaluative descriptor, each of the screens enabling assignment of a different factual descriptor from the received factual descriptors to at least one of the four areas;
the user interface module being configured to, for each of the screens, cause the user interface to display the screen and receive an assignment of the corresponding factual descriptor to at least one of the four areas of the screen; and
an assessment analysis module comprising at least one processor and configured to generate and provide a report that indicates a preference by the user for the first decision alternative over the second decision alternative, the generating being based on the assignments for each of the screens.

22. The system of claim 21, wherein:
the first identifier identifies a first product as the first decision alternative;
the second identifier identifies a second product as the second decision alternative; and
the generated report indicates a preference by the user for the first product.
